(19) United States
(12) Patent Application Publication
(10) Pub. No.: US 2015/0097057 A1
(43) Pub. Date: Apr. 9, 2015

(54) CHIP BROADCASTER TOOL

(71) Applicants: Charles Hayward, Madison Heights, MI (US); Jason Hayward, Madison Heights, MI (US)

(72) Inventors: Charles Hayward, Madison Heights, MI (US); Jason Hayward, Madison Heights, MI (US)

(21) Appl. No.: 14/068,469

(22) Filed: Oct. 31, 2013

Related U.S. Application Data
(60) Provisional application No. 61/888,138, filed on Oct. 8, 2013.

(51) Int. Cl. B05B 7/14; B05B 7/24

(52) U.S. Cl. CPC B05B 7/1486; B05B 7/1413; B05B 7/2491
USPC 239/337

(57) ABSTRACT

A chip broadcasting tool having a body that is connected to and receives pressurized air from an air source. The body further includes a first tube portion having an inlet connected to the air source and an outlet where the pressurized air exits the first tube portion. A second tube portion of the body has an inlet for receiving pressurized air and chip material. The second tube portion also has an outlet where the pressurized air and chip material exits the second tube and is broadcast away from the body. A flow chamber is positioned between a first tube portion and second tube portion such that the flow chamber is connected to the outlet of the first tube portion and the inlet of the second tube portion. Pressurized air from the outlet of the first tube portion exits the flow chamber.

### CROSS-REFERENCE TO RELATED APPLICATIONS

This application claims the benefit of U.S. Provisional Application No. 61/888,138, filed Oct. 8, 2013.

### FIELD OF THE INVENTION

The present invention relates to a chip broadcasting tool for broadcasting paint chips onto a surface.

### BACKGROUND OF THE INVENTION

In the field of wall coating systems, there have been improvements in coating materials that give walls of buildings, homes and other structures unique stone-like or a decorative feel. Such coating systems are desirable for those that wish to seal their walls and make them look decorative by having a certain color or design style. Such coating systems use an epoxy type finish coat that seals the wall surfaces making the wall easier to keep clean or resist stains, weathering or other undesirable environmental effects. Coating systems of this type usually incorporate some type of base coat combined with a clear coat. Over the base coat, paint chips, vinyl chips or other decorative chips are applied to the wall in order to give the wall an appearance of looking like stone or granite. It is also possible for the chips to have other types of desirable design elements. A clear coat is then applied over the chip material and base coat. ne of the problems encountered with developing coating systems for applying chip material onto a wall is that typical commercial applications require specially designed commercial grade equipment that uses a spray tool with a pressurized air source such as an air compressor and a hopper for holding the chip material. Commercial coating system tools also have some type of auger at the base of the hopper to mix and control the flow rate of the chip material from the hopper into the air flow stream. While this equipment is acceptable for commercial contractors, it is often times not practical for a typical residential do-it-yourself type consumer due to the cost and size of the equipment that must be purchased. There is a need to develop chip broadcasting tools that are inexpensive to produce and use a more common type of air source than an air compressor. For example, it is desirable to develop a chip broadcasting tool that can be connected with an exhaust stream of a residential or consumer vacuum, such as a shop-vacuum.

### SUMMARY OF THE INVENTION

The present invention is directed to a chip broadcasting tool having a body that is connected to and receives pressurized air from an air source. The body further includes a first tube portion having an inlet connected to the air source and an outlet where the pressurized air exits the first tube portion. A second tube portion of the body has an inlet for receiving pressurized air and chip material. The second tube portion also has an outlet where the pressurized air and chip material exit the second tube and is broadcast away from the body. A flow chamber is positioned between a first tube portion and second tube portion, such that the flow chamber is connected to the outlet of the first tube portion and the inlet of the second tube portion; and pressurized air from the outlet of the first tube portion exits the flow chamber into the inlet of the second tube portion.

A hopper has an outlet connected to a chip inlet of the flow chamber. The outlet of the hopper and the chip inlet are connected together to form a chip flow aperture. The hopper is filled with the chip material that enters the chip inlet of the flow chamber.

The flow path of the chip broadcasting tool in accordance with the present invention is defined by the inner wall of the first tube portion, the flow chamber and the second tube portion where the pressurized air from the air source flows through the body starting from the inlet of the first tube portion to the outlet of the second tube portion. The flow chamber of the present embodiment of the invention has a rounded shape, which creates a low pressure zone above the flow path forming a vacuum at the chip flow aperture that pulls chip material from the hopper through the chip flow aperture into the flow chamber.

In another aspect of the present invention, the chip broadcaster tool further includes an adjustable slide between the outlet of the hopper and the chip inlet of the flow chamber. The chip flow aperture is formed in the adjustable slide and can be moved parallel with the longitudinal axis of the body, in order to change the size of the chip flow aperture and selectively control the amount of chip material passing through the chip flow aperture.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is an environmental view of the chip broadcasting tool being used in accordance with one embodiment of the present invention;

FIG. 2 is a side perspective view of the body of a chip broadcasting tool in accordance with a first embodiment of the present invention;

FIG. 3 is an exploded side perspective view of the body of a chip broadcasting tool in accordance with a first embodiment of the present invention;

FIG. 4 is a cross-sectional side view of the body of a chip broadcasting tool in accordance with a first embodiment of the present invention;

FIG. 5 is a side perspective view of the body of a chip broadcasting tool in accordance with a second embodiment of the present invention; and

FIG. 6 is a side cross-sectional view of the body of a chip broadcasting tool in accordance with the first embodiment of the present invention.

### DETAILED DESCRIPTION OF THE PREFERRED EMBODIMENTS

The following description of the preferred embodiment(s) is merely exemplary in nature and is in no way intended to limit the invention, its application, or uses.

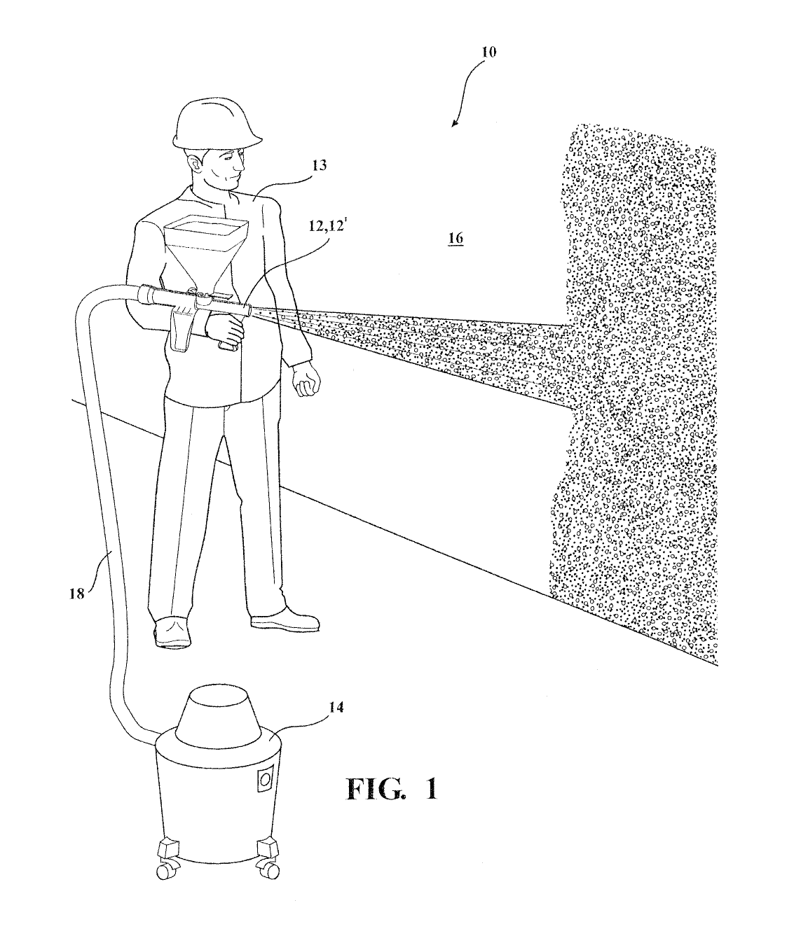

Referring to FIG. 1, a chip broadcasting tool 10 in accordance with one embodiment of the present invention is shown. The chip broadcasting tool 10 has a body 12, 12′ connected to an air source 14. A user 13 of the chip broadcasting tool 10 holds the body 12, 12′ and broadcasts or sprays an air and chip mixture from the body 12 onto a surface 16, such as a wall. The air source 14 in the present embodiment of the invention is a residential or household vacuum, such as a shop vacuum having a port that blows air through a hose 18 into the body 12, 12′. In particular where the air source 14 is a shop vacuum, the vacuum has an air flow volume of generally between 100 ft³/min. to 300 ft³/min., specifically a range of 130 ft³/min. to 250 ft³/min., or a range of 130 ft³/min. to 167 ft³/min., or a range of 167 ft³/min. to 250 ft³/min. or ideally a range of 167 ft³/min. to 229 ft³/min.

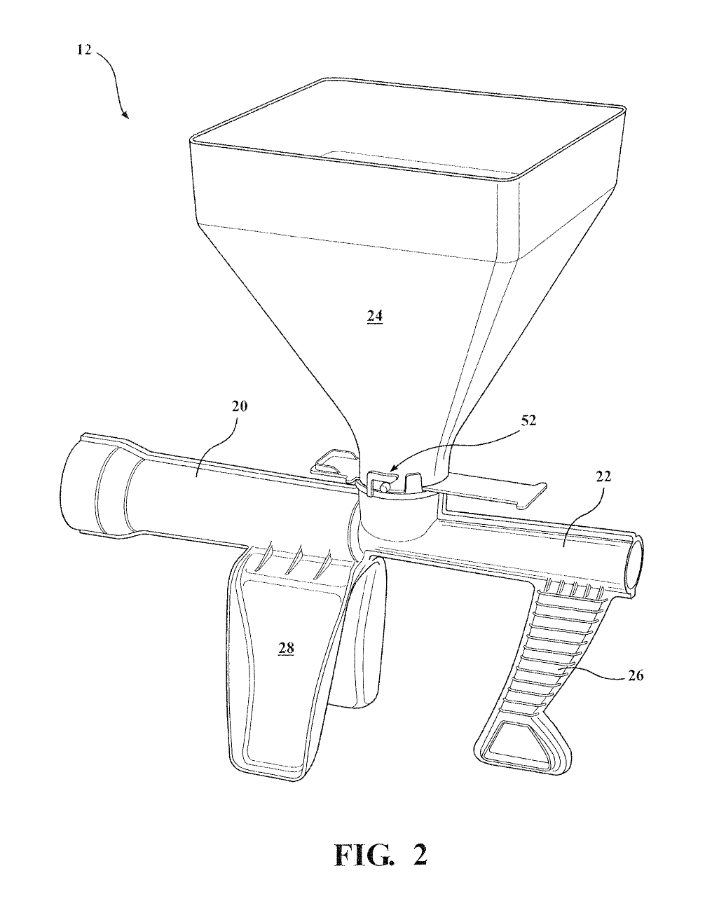

Referring to FIGS. 2, 3, 4 and 6, a first embodiment of the invention shown where the body 12 for use with the chip broadcasting tool 10 is shown. The body 12 has a first tube portion 20, a second tube portion 22 and a hopper 24. Additionally, the body 12 has a handle 26 and flexible forearm clamp 28, both of which assist a user 13 (shown in FIG. 1) in holding the body 12 in order to direct where the chip material is broadcast from the body 12.

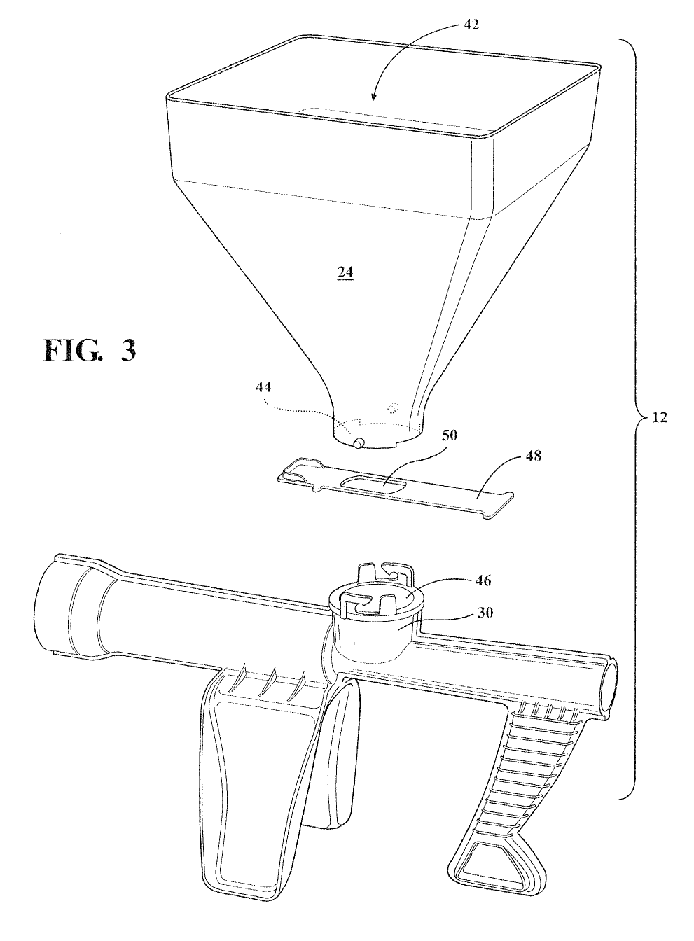

Referring to FIG. 3, an exploded perspective view shows the body 12 having the hopper 24 disassembled from a flow chamber 30.

The chip broadcasting tool arrangement 10 further includes a flow chamber 30 connected between the first tube portion 20 and second tube portion 22. The first tube portion 20 has an inlet 32 and an outlet 34. The inlet 32 is connected to the air source 14 by the hose 18. The air source 14 generates pressurized air that flows through the body 12 entering the inlet 32 of the first tube portion 20. The first tube portion 20 also has an outlet 34 that connects to the flow chamber 30. The second tube portion 22 has an inlet 36 that connects to the flow chamber 30 and receives pressurized air that flows through the first tube portion 20 onto the flow chamber 30 and into the inlet 36 of the second tube portion 22. The outlet 38 of the second tube portion 22 is where pressurized air and chip material exit the second tube portion 22 and the pressurized air and chip material are broadcast away from the body 12 onto the surface 16 (shown in FIG. 1).

The flow chamber 30 of the body 12 receives pressurized air from the outlet 34 of the first tube portion 20 and the pressurized air mixes with chip material 40 received from the hopper 24. The hopper 24 contains an area where the chip material 40 is loaded through a chip supply opening 42. The hopper 24 has an outlet 44 that connects to a chip inlet 46 of the flow chamber 30 creating a chip flow aperture 50. An adjustable slide 48 is positioned between the chip inlet 46 and the outlet 44 of the hopper 24 and provides the adjustable chip flow aperture 50 that controls the amount of chip material 40 that passes from the hopper 24 into the flow chamber 30. The adjustable slide 48 moves back and forth parallel to the axis of the first tube portion 20 and the second tube portion 22 in order to adjust the opening of the chip flow aperture 50. Chip material 40 is gravity fed into the chip flow aperture 50 of the flow chamber 30 where pressurized air moving between the outlet 34 of the first tube portion 20, through the flow chamber 30 and into the inlet of the second tube portion 22, mixes with and carries the chip material 40 from the flow chamber 30 onto the second tube portion 22.

The hopper 24 is connected to the chip inlet 46 of the flow chamber 30 by a lock tab and groove 52 formed on the hopper 24 and exterior surface of the flow chamber 30. As shown in the present embodiment of the present invention, the groove is formed on the exterior surface of the flow chamber 30, while the lock tab is formed on the surface of the hopper 24. It is within the scope of this invention for another type of connecting mechanism to be used or for the lock tab and groove to be reversed so that the groove is formed on the hopper 24 while the lock tab is formed on the flow chamber 30. Additionally, it is within the scope of this invention for other connection means to be used, such as male and female threads, fasteners and tabs, adhesives, hook and loop type fasteners, or other connection mechanisms suitable for connecting the hopper 24 to the flow chamber 30.

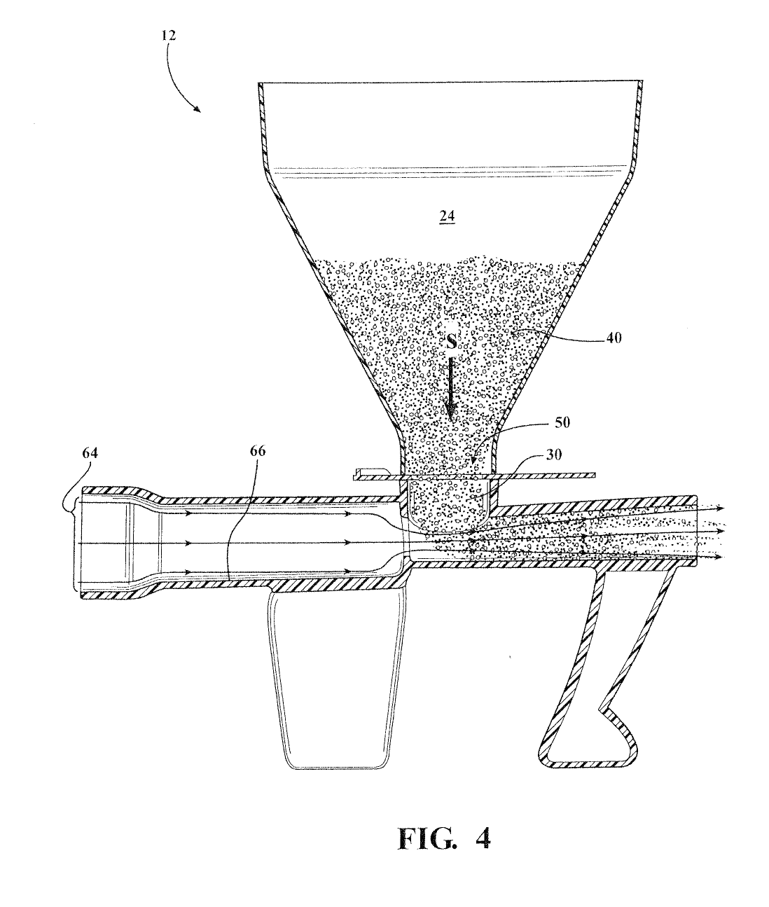

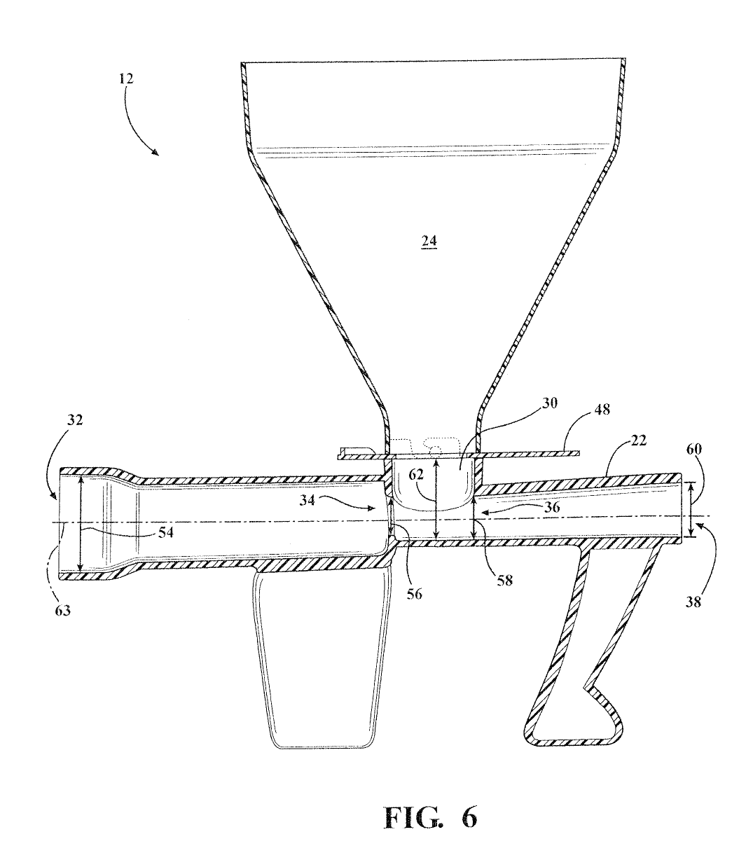

Referring now to FIGS. 4 and 6, a cross-sectional view of the body 12 is shown in accordance with one embodiment of the present invention. FIG. 6 shows a cross-sectional view of the body 12 and in particular shows the differences in the diameters of the first tube portion 20, flow chamber 30, and second tube portion 22. All of the diameters described below are measured perpendicular to a longitudinal axis 63 of the body 12. The inlet 32 of the first tube portion 20 has a diameter 54 larger or longer than a diameter 56 at the outlet 34 of the first tube portion 20. The second tube portion 22 has a diameter 58 at the inlet 36 that is smaller or shorter than the diameter 60 of the outlet 38 of the second tube portion 22. The flow chamber 30 has a central length 62 that is measured between the bottom surface of the flow chamber 30 and the bottom surface of the adjustable slide 48. The central length 62 is measured perpendicular to the longitudinal axis 63 of the body 12. The central length 62 is larger or longer than the diameter 56 of the outlet 34 of the first tube portion 20 and the diameter 58 of the inlet 36 of the second tube portion 22.

The effect of the diameters 54, 56, 58, 60 and central length 62 on pressure sir flowing through the body 12, creates a unique flow path as shown in FIG. 4, where the first tube portion 20 goes from a large diameter at the inlet 32 to a small diameter at the outlet 34, prior to entering the flow chamber 30. Once air passes through the outlet 34 of the first tube portion 20 into the flow chamber 30, the space within the flow chamber 30 is greater as shown by the central length 62. The central length 62 is also larger than the diameter 58 of the inlet 36 of the second tube portion 22. The second tube portion 22 then increases in diameter such that the diameter 60 of the outlet 38 is larger than the diameter 58 of the inlet 36.

Referring now to FIG. 4, a flow path 64 is shown to go from a wide flow path to a more narrow flow path prior to entering the flow chamber 30, where the chip material is introduced from the hopper 24. Once the chip material 40 from the hopper 24 to the flow chamber 30, the mixture of pressurized air and chip material 40 flows into the inlet 36 of the second tube portion 22 where the diameter of the second tube portion 22 increases from the inlet 36 to the outlet 38. The flow path 64 shown in FIG. 4 is influenced by the inner walls 66 of the first tube portion 20, flow chamber 30 and second tube portion 22. As the pressurized air flows through the outlet 34 of the first tube portion 20 into the flow chamber 30, a suction S is created that pulls chip material 40 from the hopper 24 downward into the flow chamber 30. The various diameters 54, 56, 58, 60 and central length 62 associated with the present embodiment of the invention create the suction S which forms a vacuum at the chip flow aperture 50 which pulls chip material 40 from the hopper 24 through the chip flow aperture 50 into the flow chamber 30. This eliminates the need for there to be an auger or other mixing device at the base of the hopper, which is required with commercial line chip broadcasting tools. Instead, the flow path 64 of the present invention pulls the chip material from the hopper 24 into the flow chamber 30 by using gravity and vacuum suction, which eliminates backflow of air into the hopper 24. Additionally, the use of the adjustable slide 48 that allows for the adjustment of the size of the chip flow aperture 50 helps to control the flow of the chip material 40 from the hopper 24 into the flow chamber 30.

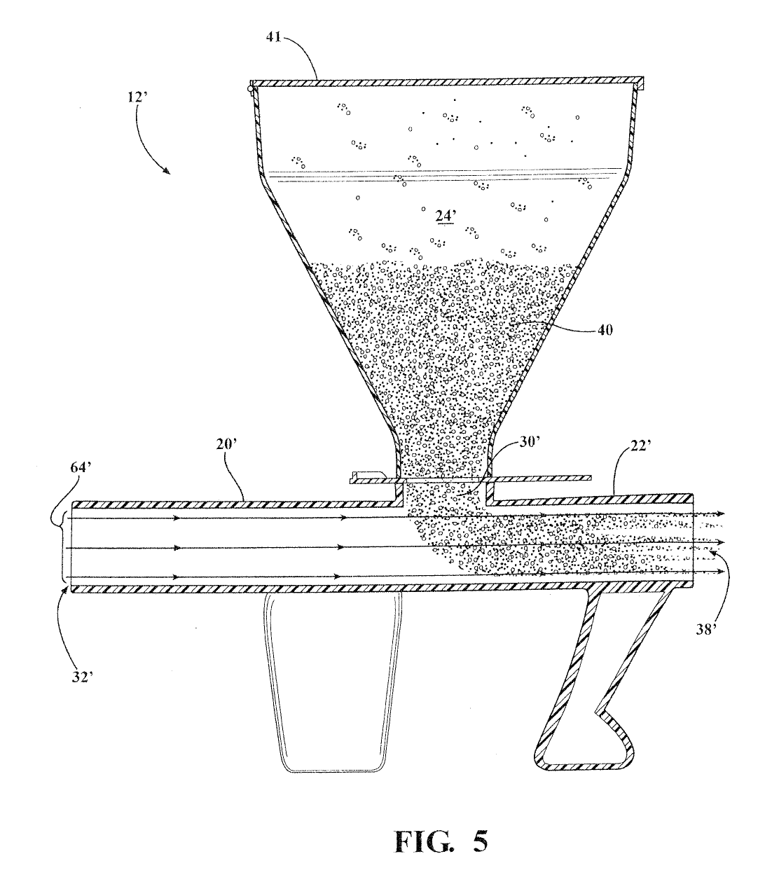

FIG. 5 depicts a cross-sectional view of a body 12′ that is used in connection with the chip broadcasting tool arrangement 10 as shown in FIG. 1. The body 12 shown in FIG. 5 differs from the embodiment shown in the other Figures in that a first tube portion 20′, flow chamber 30′ and second tube portion 22′ do not have a change in diameter and thus have a different flow path 64′ that remains substantially constant between an inlet 32′ of the first tube portion 20′ and an outlet 38′ of the second tube portion 22′. The difference in the flow path 64′ creates some backflow of air into the hopper 24, which will cause some of the chip material 40 to be airborne. In order to prevent the chip material 40 from flying out of the hopper 24, a lid 41 is placed on the top of the hopper 24. The lid 41 can be hinged and connected to the hopper or it can be a separate connection using flanges or a threaded connection. Additionally, it is possible for the lid to be used on the tool body 12 in accordance with the first embodiment of the invention since the lid 41 will also prevent chip material 40 from exiting the hopper 24 in the event that the tool body 12, 12′ is turned upside down or laid on its side. The present embodiment of the present invention shown in FIG. 5 has a different flow path 64′ that can be more useful for different types of chip material 40 and may be more desirable for specific applications. For example, it is within the scope of this invention for the chip material 40 to be of different sizes and/or shapes and/or densities; therefore, one of the flow paths 64, 64′ may be more desirable for a particular type of application. Thus, one of the tool bodies 12, 12′ may be more desirable for use.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A chip broadcasting tool comprising:
an air source for generating pressurized air;
a body connected to and receiving pressurized air from the air source;
a first tube portion of the body having an inlet of the first tube portion connected to the air source and an outlet of the first tube portion where the pressurized air exits the first tube portion;
a second tube portion of the body having an inlet of the second tube portion for receiving pressurized air and a chip material and an outlet of the second tube portion where the pressurized air and the chip material exits the second tube and is broadcast away from the body
a flow chamber of the body connected to the outlet of the first tube portion and the inlet of the second tube portion, where the pressurized air from the outlet of the first tube exits the flow chamber;
a hopper having an outlet of the hopper connected to a chip inlet of the flow chamber, where the outlet of the hopper and the chip inlet connect creates a chip flow aperture, wherein the hopper contains the chip material that enters the chip inlet of the flow chamber, mixed with pressurized air from the air source and the pressurized air and chip material exits the flow chamber though the inlet of the second tube portion;
an adjustable slide between the outlet of the hopper and the chip inlet of the flow chamber, wherein the adjustable slide changes the size of the chip flow aperture and selectively controls the amount of chip material passing through the chip flow aperture.

2. The chip broadcasting tool of claim 1 further comprising a chip supply opening on the hopper for adding chip material to the hopper, wherein the chip supply opening further includes a lid for covering the chip supply opening.

3. The chip broadcasting tool of claim 1 further comprising a lock tab and groove connection between the hopper and the body for removably connecting the hopper to the body at the chip inlet of the flow chamber.

4. The chip broadcasting tool of claim 1 wherein the air source is provided by an exhaust outlet of a shop vacuum.

5. The chip broadcasting tool of claim 4 wherein the shop vacuum has an air flow volume in one range selected from the group consisting of 100 ft³/min to 300 ft³/min, 130 ft³/min to 250 ft³/min, 130 ft³/min to 167 ft³/min, 167 ft³/min to 250 ft³/min and 167 ft³/min to 229 ft³/min.

6. The chip broadcasting tool of claim 1 further comprising a handle formed on an outside surface of the body allowing a user to hold the body and direct where the chip material is broadcast from the chip broadcasting tool.

7. The chip broadcasting tool of claim 6 further comprising a flexible forearm clamp formed on the outside surface of the body for clamping and supporting the chip broadcasting tool.

8. The chip broadcasting tool of claim 1 further comprising:
a diameter of the inlet of the first tube portion measured perpendicular to the longitudinal axis of the body is larger than a diameter of the outlet of the first tube portion measured perpendicular to the longitudinal axis of the body;
a diameter of the inlet of the second tube portion measured perpendicular to the longitudinal axis of the body is smaller than the diameter of the outlet of the second tube portion measured perpendicular to the longitudinal axis of the body; and
a central length of the flow chamber that the measured perpendicular to the longitudinal axis of the body is larger than both the diameter of the outlet of the first tube portion and the diameter of the inlet of the second tube portion.

9. A chip broadcasting tool comprising:
an air source for generating pressurized air;
a body connected to and receiving pressurized air from the air source;
a first tube portion of the body having an inlet of the first tube portion connected to the air source and an outlet of the first tube portion where the pressurized air exits the first tube portion;
a second tube portion of the body having an inlet of the second tube portion for receiving pressurized air and a chip material and an outlet of the second tube portion where the pressurized air and the chip material exits the second tube and is broadcast away from the body
a flow chamber of the body connected to the outlet of the first tube portion and the inlet of the second tube portion, where the pressurized air from the outlet of the first tube exits the flow chamber, wherein the flow chamber has a rounded cross-section with a central length larger than a diameter of the outlet of the first tube portion and the diameter of the inlet of the second tube portion
a hopper having an outlet of the hopper connected to a chip inlet of the flow chamber, where the outlet of the hopper and the chip inlet create a chip flow aperture, wherein the hopper contains the chip material that enters the chip inlet of the flow chamber, mixed with pressurized air from the air source and the pressurized air and chip material exits the flow chamber though the inlet of the second tube portion;
a flow path defined by the inner walls of the first tube portion, the flow chamber and the second tube portion where the pressurized air from the air source flows through the body from the inlet of the first tube portion to the outlet of the second tube portion, wherein the rounded cross-section creates a low pressure zone above the flow path forming a vacuum at the chip flow aperture that pulls chip material from the hopper through the chip flow aperture into the flow chamber.

10. The chip broadcasting tool of claim 9 further comprising an adjustable slide between the outlet of the hopper and the chip inlet of the flow chamber, wherein the adjustable slide changes the size of the chip flow aperture and selectively controls the amount of chip material passing through the chip flow aperture.

11. The chip broadcasting tool of claim 9 further comprising a chip supply opening on the hopper for adding chip material to the hopper, wherein the chip supply opening further includes a lid for covering the chip supply opening.

12. The chip broadcasting tool of claim 9 further comprising a lock tab and groove connection between the hopper and the body for removably connecting the hopper to the body at the chip inlet of the flow chamber.

13. The chip broadcasting tool of claim 9 wherein the air source is provided by an exhaust outlet of a shop vacuum.

14. The chip broadcasting tool of claim 13 wherein the shop vacuum has an air flow volume in one range selected from the group consisting of 100 ft³/min to 300 ft³/min, 130 ft³/min to 250 ft³/min, 130 ft³/min to 167 ft³/min, 167 ft³/min to 250 ft³/min and 167 ft³/min to 229 ft³/min.

15. The chip broadcasting tool of claim 9 further comprising a handle formed on an outside surface of the body allowing a user to hold the body and direct where the chip material is broadcast from the chip broadcasting tool.

16. The chip broadcasting tool of claim 15 further comprising a flexible forearm clamp formed on the body for clamping and supporting the chip broadcasting tool.

17. The chip broadcasting tool of claim 9 further comprising:
a diameter of the inlet of the first tube portion measured perpendicular to the longitudinal axis of the body is larger than the diameter of the outlet of the first tube portion; and
the diameter of the inlet of the second tube portion is smaller than a diameter of the outlet of the second tube portion measured perpendicular to the longitudinal axis of the body.
